(19) United States
(12) Patent Application Publication
(10) Pub. No.: US 2020/0156574 A1
(43) Pub. Date: May 21, 2020

(54) BUMPER REINFORCEMENT AND FRONT VEHICLE BODY STRUCTURE

(71) Applicant: AISIN SEIKI KABUSHIKI KAISHA, Kariya-shi (JP)

(72) Inventors: Tomoki MITSUYA, Kariya-shi (JP); Yusuke HIBINO, Kariya-shi (JP); Kiyoichi KITA, Okazaki-shi (JP); Jun SHOBO, Anjo-shi (JP); Kyosuke MATSUI, Anjo-shi (JP)

(73) Assignee: AISIN SEIKI KABUSHIKI KAISHA, Kariya-shi (JP)

(21) Appl. No.: 16/685,524

(22) Filed: Nov. 15, 2019

(30) Foreign Application Priority Data
Nov. 16, 2018 (JP) 2018-215532

(51) Int. Cl. B60R 19/12; B62D 25/08

(52) U.S. Cl. CPC B60R 19/12; B60R 19/34; B62D 25/084

(57) ABSTRACT

A bumper reinforcement includes a bumper reinforcement body that is disposed below a grille shutter and an impact transmission portion that is the same material as the bumper reinforcement body and is integral with the bumper reinforcement body. The bumper reinforcement body is a resin member. The impact transmission portion is configured to come into contact with a radiator support supporting a radiator at the time of collision to transmit an impact load to the radiator support.

### CROSS-REFERENCE TO RELATED APPLICATION

This application claims priority to Japanese Patent Application No. 2018-215532 filed on Nov. 16, 2018, incorporated herein by reference in its entirety.

### BACKGROUND

### 1. Technical Field

The invention relates to a bumper reinforcement and a front vehicle body structure.

### 2. Description of Related Art

A front vehicle body structure including a bumper reinforcement below a grille shutter is known (for example, Japanese Patent Application Publication No. 2018-90060 (JP 2018-90060 A)). A bumper reinforcement absorbs an impact at the time of collision of a vehicle.

### SUMMARY

In the above-mentioned bumper reinforcement, crash resistance is secured, for example, by forming the bumper reinforcement out of a metallic member of aluminum or iron. On the other hand, in order to decrease a weight for the purpose of improving fuel efficiency of a vehicle, changing the material of the bumper reinforcement from a metallic member to a resin member can be considered, but there is concern that simply changing to a resin member may not provide satisfactory crash resistance.

The invention provides a bumper reinforcement and a front vehicle body structure that can secure crash resistance even when formed of a resin member.

A first aspect of the present invention provides a bumper reinforcement. The bumper reinforcement includes a bumper reinforcement body that is disposed below a grille shutter and an impact transmission portion that is the same material as the bumper reinforcement body and is integral with the bumper reinforcement body. The bumper reinforcement body is a resin member. The impact transmission portion is configured to come into contact with a radiator support supporting a radiator at the time of collision to transmit an impact load to the radiator support.

With this configuration, since the impact transmission portion which is the same material as the bumper reinforcement body and is integral with the bumper reinforcement body can come into contact with the radiator support at the time of collision to transmit an impact load to the radiator support, it is possible to secure crash resistance even when the bumper reinforcement is formed of a resin member.

A second aspect of the present invention provides a front vehicle body structure. The front vehicle body structure includes a bumper reinforcement and a grille shutter that is located above the bumper reinforcement. The bumper reinforcement includes a bumper reinforcement body that is disposed below the grille shutter and an impact transmission portion that is the same material as the bumper reinforcement body and is integral with the bumper reinforcement body. The bumper reinforcement body is a resin member. The impact transmission portion is configured to come into contact with a radiator support supporting a radiator at the time of collision to transmit an impact load to the radiator support. The grille shutter is the same material as the bumper reinforcement and is integral with the bumper reinforcement body.

With this configuration, since the bumper reinforcement and the grille shutter are integrally formed as a single body, it is possible to omit fixation of the grille shutter to a vehicle body by fastening or the like by fixing the bumper reinforcement to the vehicle body. Accordingly, since it is not necessary to provide a fixing portion for fixing the grille shutter to the vehicle body, it is possible to increase an opening area of the grille shutter.

The bumper reinforcement and the front vehicle body structure according to the invention can secure crash resistance even when formed of a resin member.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view of a front vehicle body structure according to an embodiment;

FIG. 2A is a perspective view illustrating a bumper reinforcement, a grille shutter, and a radiator support according to one embodiment;

FIG. 2B is a perspective view illustrating a bumper reinforcement and a grille shutter according to one embodiment;

FIG. 3 is a perspective view illustrating a bumper reinforcement, a grille shutter, and a radiator support according to one embodiment;

FIG. 4 is a front view illustrating a bumper reinforcement, a grille shutter, and a radiator support according to one embodiment; and

FIG. 5 is a front view illustrating a bumper reinforcement, a grille shutter, and a radiator support according to a reference example.

### DETAILED DESCRIPTION OF EMBODIMENTS

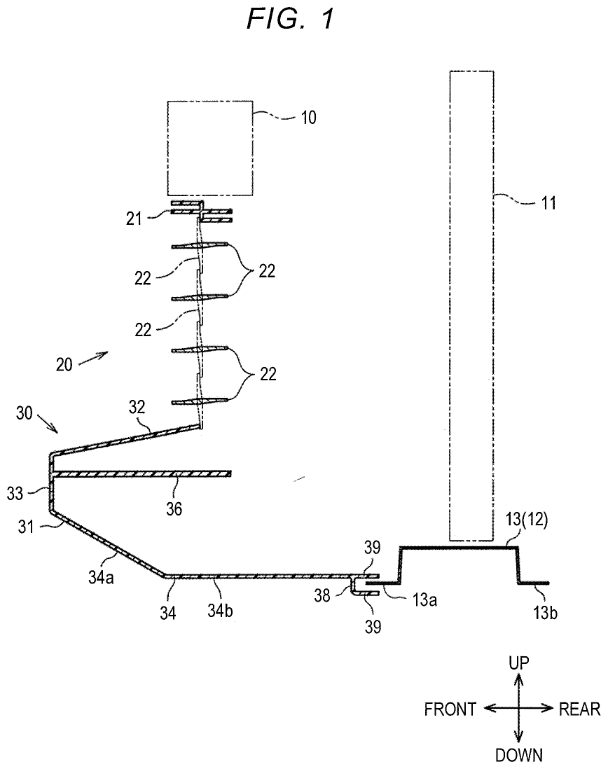

Hereinafter, a front vehicle body structure according to an embodiment of the invention will be described with reference to the accompanying drawings. In the following description, as illustrated in FIG. 1, the front vehicle body structure includes an upper bumper reinforcement 10, a grille shutter 20, and a lower bumper reinforcement 30. The upper bumper reinforcement 10, the grille shutter 20, and the lower bumper reinforcement 30 are provided in front of a radiator 11 that cools an engine.

The radiator 11 is provided, for example, in front of the engine and is supported by a radiator support 12. As illustrated in FIGS. 1 and 4, the radiator support 12 includes an upper support (not illustrated) and a lower support 13 that extend in a width direction of a vehicle and a pair of side supports 14 that connect the upper support and the lower support 13. That is, the radiator support 12 is formed in a rectangular frame shape when seen in a front-rear direction of a vehicle (in a front view of a vehicle). The radiator support 12 is formed of, for example, a metallic member.

As illustrated in FIG. 1, the lower support 13 is formed such that cross sections in the front-rear direction and the vertical direction of the vehicle have hat shapes. More specifically, the lower support 13 includes a front end portion 13a and a rear end portion 13b having a flange shape that extends in the front-rear direction. The front end portion 13a extends forward and the rear end portion 13b extends rearward.

As illustrated in FIG. 1, the upper bumper reinforcement 10 is located above the grille shutter 20. The upper bumper reinforcement 10 is formed of, for example, a metal material. A configuration in which a bumper absorber is provided in front of the upper bumper reinforcement 10 may be employed.

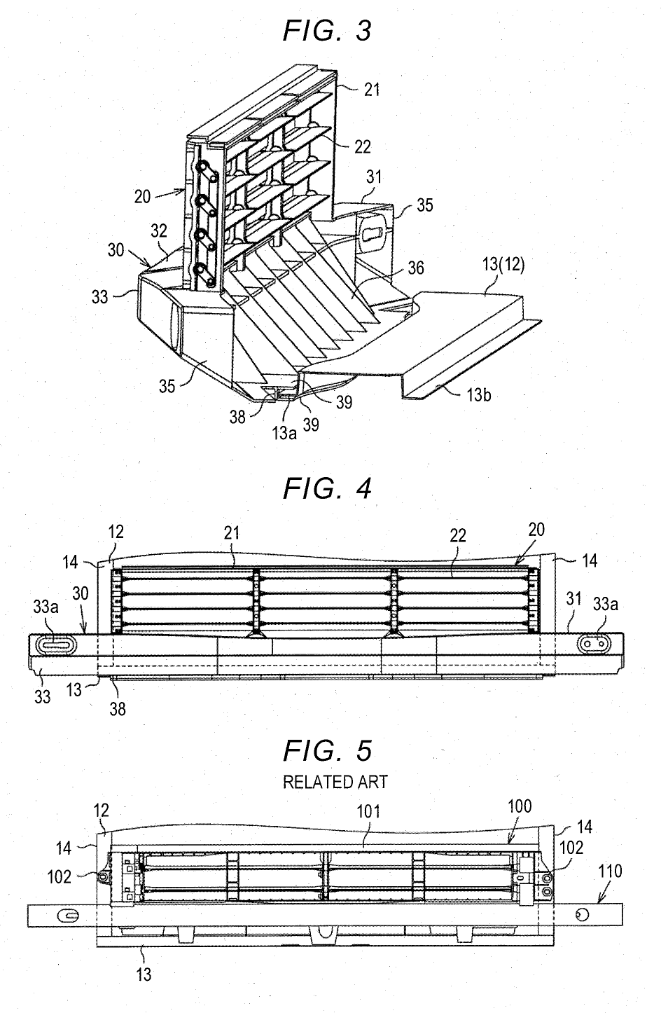

As illustrated in FIGS. 1 to 3, the grille shutter 20 includes a support frame portion 21 having a substantially rectangular frame shape and a plurality of movable fins 22 that is supported by the support frame portion 21. The movable fins 22 are rotationally driven by an actuator (not illustrated) which is constituted by, for example, a motor with a reduction gear. The movable fins 22 adjust a flow rate of air which flows into an engine compartment by changing an amount of opening of the support frame portion 21 with the rotational driving.

The lower bumper reinforcement 30 that is integrally formed with the support frame portion 21 is provided below the support frame portion 21 of the grille shutter 20. As illustrated in FIG. 1, the lower bumper reinforcement 30 is located below the grille shutter 20. The lower bumper reinforcement 30 is formed of a resin member. The lower bumper reinforcement 30 is integrally formed with the grille shutter 20.

The lower bumper reinforcement 30 includes a bumper reinforcement body 31 and an impact transmission portion 38. The bumper reinforcement body 31 includes a top plate portion 32 that extends forward from the grille shutter 20 to be continuous with the grille shutter 20, a front plate portion 33 that extends downward from a tip (a front end) of the top plate portion 32, and a bottom plate portion 34 that extends rearward from the tip (a lower end) of the front plate portion 33. The top plate portion 32 and the front plate portion 33 are formed such that cross sections in the front-rear direction and the vertical direction have straight shapes. The bottom plate portion 34 is formed such that cross sections in the front-rear direction and the vertical direction are bent along the way. More specifically, a front side portion 34a of the bottom plate portion 34 is formed to be inclined in the front-rear direction, and a rear side portion 34b of the bottom plate portion 34 is formed to be parallel to the front-rear direction.

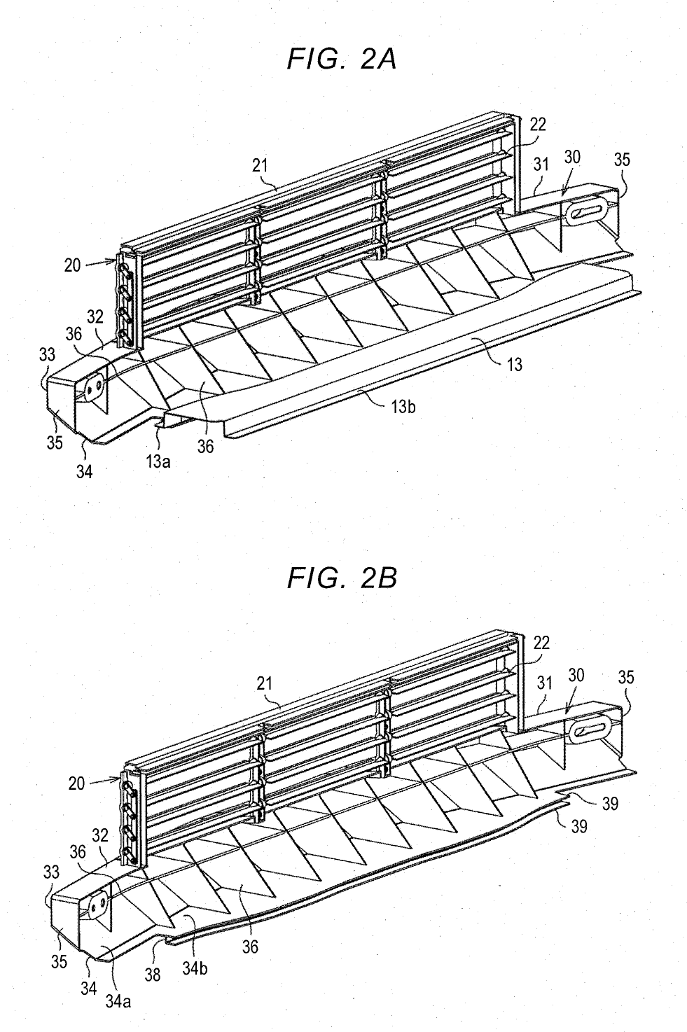

The bumper reinforcement body 31 includes side plate portions 35 that connect the ends of the top plate portion 32, the front plate portion 33, and the bottom plate portion 34 on both sides in a width direction of the vehicle. As illustrated in FIGS. 2A and 2B, the bumper reinforcement body 31 includes a plurality of ribs 36 in a part which is surrounded by the top plate portion 32, the front plate portion 33, the bottom plate portion 34, and the side plate portions 35. The number or arrangement of ribs 36 is not limited to the configuration illustrated in FIGS. 2A and 2B and can be appropriately changed.

As illustrated in FIGS. 1 to 3, the impact transmission portion 38 is provided at a tip (a rear end) of the rear side portion 34b of the bottom plate portion 34. The impact transmission portion 38 is formed to extend downward from the tip (the rear end) of the rear side portion 34b of the bottom plate portion 34 and is disposed to face the front end portion 13a of the lower support 13 in the front-rear direction in a state in which the lower bumper reinforcement 30 is attached to the vehicle body. A gap is formed between the impact transmission portion 38 and the front end portion 13a.

As illustrated in FIGS. 1 and 2B, extension portions 39 that extend rearward (to the lower support 13 side) are provided at both ends in the vertical direction of the impact transmission portion 38. Two extension portions 39 are formed to be long in the width direction of the vehicle. The two extension portions 39 are disposed to surround the front end portion 13a of the lower support 13 from both sides in the vertical direction. Accordingly, a labyrinthine structure is formed by the impact transmission portion 38, the extension portions 39, and the front end portion 13a.

As illustrated in FIG. 4, fixing holes 33a are formed on both sides of the front plate portion 33 of the bumper reinforcement body 31 in the width direction of the vehicle, and the lower bumper reinforcement 30 is fastened to the radiator support 12 using the fixing holes 33a, for example, with bolts. The method of fixing the lower bumper reinforcement 30 is not limited to fastening with bolts and another fixing method may be employed.

Operations of this embodiment will be described below. The lower bumper reinforcement 30 according to this embodiment is formed of a resin member, and the impact transmission portion 38 is disposed to face the front end portion 13a of the lower support 13 of the radiator support 12 in the front-rear direction. Accordingly, the impact transmission portion 38 comes into contact with the front end portion 13a due to an impact when the vehicle collides and an impact load is transmitted to the lower support 13. That is, the impact load can be received by the lower support 13 which is formed of a metallic member, and thus it is possible to secure crash resistance even when the lower bumper reinforcement 30 is formed of a resin member.

A grille shutter 100 which is separate from a bumper reinforcement will be described below as a reference example with reference to FIG. 5. As illustrated in FIG. 5, the grille shutter 100 is provided above a lower bumper reinforcement 110 to be separate from the lower bumper reinforcement 110. The grille shutter 100 includes a fixing portion 102 for fixing the grille shutter 100 to the radiator support 12 on both sides of a support frame portion 101 having a rectangular frame shape in the width direction of the vehicle. That is, when the grille shutter is separate from the lower bumper reinforcement, the fixing portions 102 which are structures for fixing the grille shutter 100 need to be provided. The fixing portions 102 are fixed to the front surface of the radiator support 12. Accordingly, the opening area of the grille shutter 100 (the support frame portion 101) in the reference example is limited.

On the other hand, in this embodiment, since the lower bumper reinforcement 30 and the grille shutter 20 are integrally formed of the same material as described above, it is not necessary to separately fix the grille shutter 20 (the support frame portion 21) by fixing the lower bumper reinforcement 30. Accordingly, since the above-mentioned fixing portions do not need to be provided in the grille shutter 20, the opening area of the grille shutter 20 (the support frame portion 21) can be enlarged by omitting the fixing portions.

Advantageous effects of this embodiment will be described below. Since the impact transmission portion 38 which is integrally formed of the same material as the bumper reinforcement body 31 can come into contact with the radiator support 12 at the time of collision in the front-rear direction to transmit an impact load to the radiator support 12, it is possible to secure crash resistance even when the lower bumper reinforcement 30 is formed of a resin member.

By interposing the radiator support 12 between the extension portions 39 serving as the regulation portion of the impact transmission portion 38, vertical movement of the radiator support 12 relative to the impact transmission portion can be regulated. Since a space between the extension portions 39 and the radiator support 12 can be formed in a labyrinthine structure by interposing the radiator support 12 between the extension portions 39, it is possible to curb leakage of air to the outside from the space between the extension portions 39 and the radiator support 12.

Since the impact transmission portion can come into contact with the radiator support 12 (the lower support 13) at the time of collision in the front-rear direction to transmit an impact load to the radiator support 12, it is possible to secure crash resistance even when the lower bumper reinforcement 30 is formed of a resin member.

Since the lower bumper reinforcement 30 and the grille shutter 20 are integrally formed as a single body, fixing the grille shutter 20 to the vehicle body by fastening with bolts or the like can be omitted by fixing the lower bumper reinforcement 30 to the vehicle body. Accordingly, since no fixing portion for fixation to the vehicle body needs to be provided in the grille shutter 20, it is possible to increase the opening area of the grille shutter 20 (to increase a length in the width direction of the vehicle).

The above embodiment can be modified as follows. The embodiment and the following modified examples can be combined with each other for implementation as long as no technical contradictions arise.

The above embodiment employs a configuration in which the extension portions 39 are provided as a regulation portion, but a configuration in which the extension portions 39 are omitted may be employed. For example, the extension portions 39 may be omitted and a cross section having an L-shape may be formed by the bottom plate portion 34 and the impact transmission portion 38.

The above embodiment employs a configuration in which the impact transmission portion 38 extends downward and in which the front end portion 13a of the lower support 13 faces the surface formed by the impact transmission portion 38, but the invention is not limited thereto. A configuration in which the impact transmission portion extends rearward may be employed. A configuration in which the impact transmission portion 38 is disposed to face a portion other than the front end portion 13a of the lower support 13 and the impact transmission portion 38 and the lower support 13 come into contact with each other at the time of collision to transmit an impact load to the lower support 13 may be employed.

The above embodiment employs the upper bumper reinforcement 10 as the front vehicle body structure, but a configuration in which the upper bumper reinforcement 10 is omitted may be employed. In the above embodiment, the lower bumper reinforcement 30 which is a bumper reinforcement and the grille shutter 20 are formed integrally as a single body, but they may be formed separately.

In the bumper reinforcement, the impact transmission portion may include a regulation portion configured to regulate vertical movement of the radiator support relative to the impact transmission portion by interposing the radiator support in a vertical direction.

With this configuration, vertical movement of the radiator support relative to the impact transmission portion can be regulated by pinching the radiator support using the regulation portion of the impact transmission portion in the vertical direction. Since a space between the regulation portion and the radiator support can be formed in a labyrinthine structure by interposing the radiator support using the regulation portion, it is possible to curb leakage of air to the outside via the space between the regulation portion and the radiator support.

In the bumper reinforcement, the impact transmission portion may be configured to come into contact with the radiator support at the time of collision to transmit the impact load to the radiator support. The radiator support may be located lower than the radiator.

With this configuration, since the impact transmission portion can come into contact with the radiator support located at a lower position at the time of collision to transmit an impact load to the radiator support, it is possible to secure crash resistance even when the bumper reinforcement is formed of a resin member.

What is claimed is:

1. A bumper reinforcement comprising:
a bumper reinforcement body that is disposed below a grille shutter, the bumper reinforcement body being a resin member; and
an impact transmission portion that is the same material as the bumper reinforcement body and is integral with the bumper reinforcement body, the impact transmission portion being configured to come into contact with a radiator support supporting a radiator at a time of collision to transmit an impact load to the radiator support.

2. The bumper reinforcement according to claim 1, wherein the impact transmission portion includes a regulation portion configured to regulate vertical movement of the radiator support relative to the impact transmission portion by interposing the radiator support in a vertical direction.

3. The bumper reinforcement according to claim 1, wherein the impact transmission portion is configured to come into contact with the radiator support at the time of collision to transmit the impact load to the radiator support and the radiator support is located lower than the radiator.

4. A front vehicle body structure comprising:
a bumper reinforcement; and
a grille shutter that is located above the bumper reinforcement,
wherein the bumper reinforcement includes a bumper reinforcement body that is disposed below the grille shutter and an impact transmission portion that is the same material as the bumper reinforcement body and is integral with the bumper reinforcement body, the bumper reinforcement body is a resin member, and the impact transmission portion is configured to come into contact with a radiator support supporting a radiator at a time of collision to transmit an impact load to the radiator support, and
the grille shutter being the same material as the bumper reinforcement and is integral with the bumper reinforcement body.
